(19) United States
(12) Patent Application Publication
(10) Pub. No.: US 2009/0028984 A1
(43) Pub. Date: Jan. 29, 2009

(54) Transition Channel For Use Between A First Conduit And A Second Conduit In A Molding System

(75) Inventor: Maciej Aleksander BRELSKI, Brampton (CA)

Correspondence Address: HUSKY INJECTION MOLDING SYSTEMS, LTD;CO/AMC INTELLECTUAL PROPERTY GRP, 500 QUEEN ST. SOUTH, BOLTON, ON, L7E 5S5, CA

(73) Assignee: Husky Injection Molding Systems Ltd.

(21) Appl. No.: 11/828,744

(22) Filed: Jul. 26, 2007

(51) Int. Cl. B29C 45/20

(52) U.S. Cl. 425/549; 425/564; 425/567; 425/568

(57) ABSTRACT

Disclosed herein is a transition channel for conveying fluid between a first conduit and a second conduit in a molding system. For example, there is disclosed a transition channel for providing a flow path between a first conduit having a first cross-section and a second conduit having a second cross-section in a molding system, the transition channel configured to have a shape that follows a curve that substantially corresponds to melt natural stream lines.

### FIELD OF THE INVENTION

The present invention relates, generally, to a molding system and more particularly, but not necessarily limited to, a transition channel for use between a first conduit and a second conduit in the molding system.

### BACKGROUND INFORMATION

Fluid flowing in a channel naturally loses its energy due to viscous friction (wall shear) and changes in the direction of the flow. In a straight channel flow, the energy of the fluid is dissipated due to the viscous friction. Sudden changes in the channel direction or cross-section of the flow path cause additional losses of energy because of the possible creation of recirculation zones and separation of the boundary layer. Local restrictions in the channel can increase the rate of deformation (shear strain rate) of the fluid.

For some fluids (such as oils or polymer melts), this can result in appreciable viscous (shear) heating causing a local increase in fluid temperature. Since the material properties of polymer melts are strongly dependent on temperature and shear strain rate, a local increase of the deformation rate and temperature creates variations of density and viscosity of the fluid. It is believed that a resulting inhomogeneous melt can negatively influence the quality of the final molded article and create a mold runner imbalance.

A local reduction of fluid velocity due to a sudden change in channel cross-section may locally increase fluid residence time in one area and create zones with reduced velocity of flow in the melt channel. This can create a problem, for example, where it is desired to make a color change as material from the earlier injection process may remain in the zone with reduced velocity and subsequently contaminate the new melt of a different color.

Traditionally, channels for conveying melt (i.e. transition devices for conveying melt) have been made as simple cylindrical and conical shapes. These shapes result in sudden changes in cross-sections of the channel. Examples of such channels can be found in various parts of a molding system (such as, for example, an injection molding system and the like).

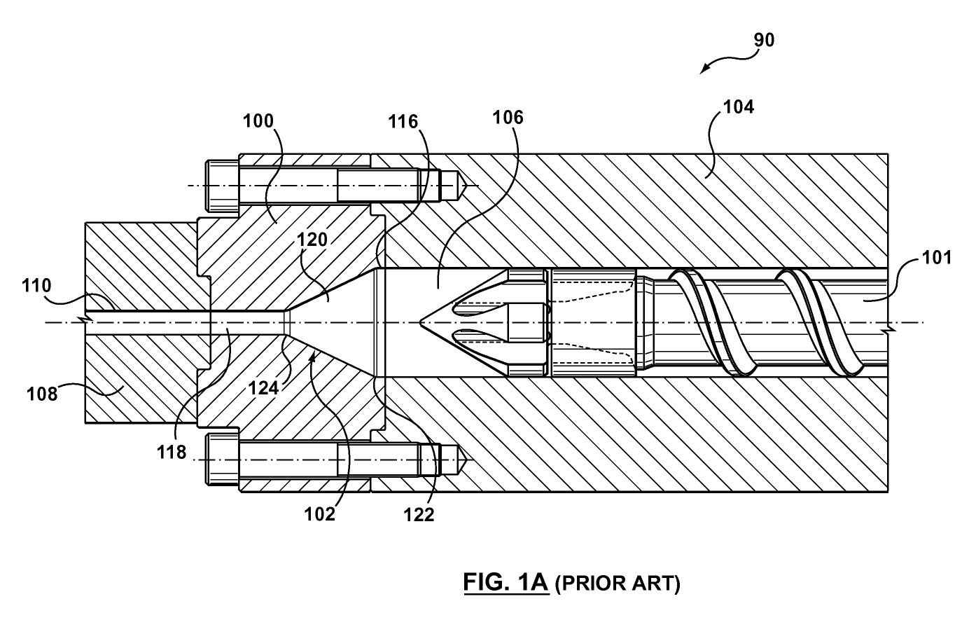

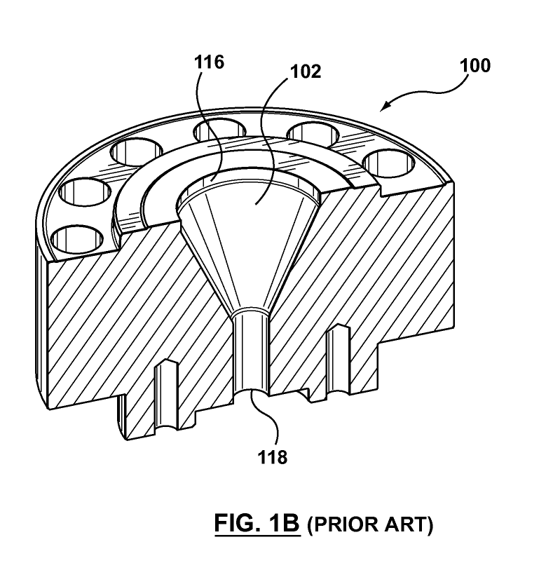

An example of such a prior art channel for conveying fluid, such as melt, is illustrated with reference to FIG. 1A and FIG. 1B. FIG. 1A depicts a partial sectional view of a barrel assembly 90 implemented in accordance with known prior art techniques, including a barrel head 100 for a known molding machine (not depicted) and FIG. 1B depicts a schematic perspective view of the barrel head 100 of FIG. 1A.

The barrel assembly 90 includes a barrel portion 104, fluidly connected, in use, to a machine nozzle 108 via a barrel head 100. The barrel assembly 90 further comprises a screw 101. Solid material (such as, but not limited to, PET pellets, PET powder and the like) is fed into the barrel portion 106 and through rotation of the screw 101, the solid material is transformed into a melt, at least partially, by shearing action between the screw 101 and the barrel portion 106, as well as due to heat emitted by barrel heaters (not separately depicted). Typically, while creating the melt in the barrel portion 106, it is desirable to combine the shearing action of the screw and the heating action of the heaters on the barrel so that the melt reaches a desired temperature and viscosity in minimal time.

The barrel head 100 is configured to transition the melt from the barrel portion 104 having a first channel 106, the first channel 106 having a first cross-section, to the machine nozzle 108 having a second channel 110, the second channel 110 having a second cross section. It can be clearly seen in FIG. 1A that the first cross-section is greater than the second cross-section.

To that extent, the barrel head 100 comprises an internal channel 102. Generally speaking, the internal channel 102 comprises three transition regions. A first transition region 116 (can also be thought of as a “entry portion”), a second transition region 118 (can also be thought of as an “exit portion”) and a third transition region 120 (can also be thought of as a “transition portion”), the third transition region 120 being disposed between the first transition region 116 and the second transition region 118. The first transition region 116 and the second transition region 118 are substantially cylindrical, while the third transition region 116 is substantially conical. It can be seen that the first transition region 116 has a cross-section that generally corresponds to the first cross-section of the first channel 110 and a cross-section of the second transition region 118 generally corresponds to the second cross-section of the second channel 110. Accordingly, it can be said that the third transition region 120 provides a transition channel defining a flow path between a first conduit having a larger cross-section (i.e. the first transition region 116) and a second conduit having a smaller cross-section (i.e. the second transition region 118).

It can be said that there exists a first sharp discontinuity 122 where the first region 116 meets the third region 120 and a second sharp discontinuity 124 where the second region 118 meets the third region 120. It is believed that the first sharp discontinuity 122 and the second sharp discontinuity 124 can hamper the smooth flow of the melt.

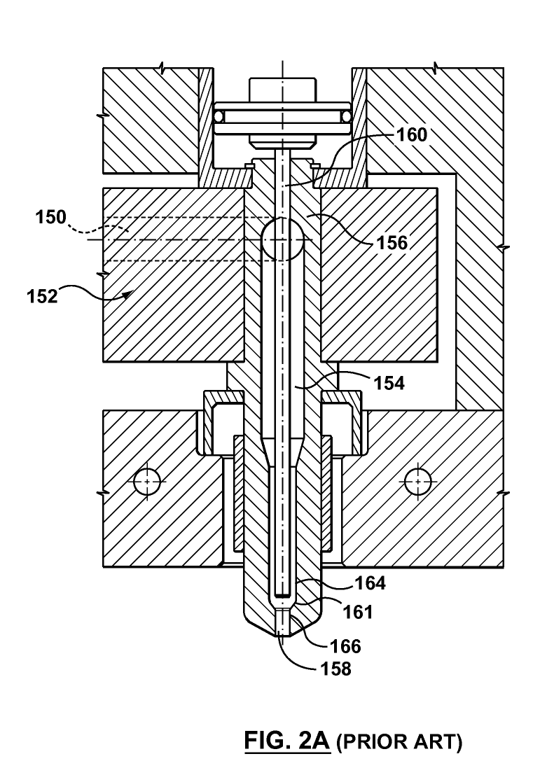

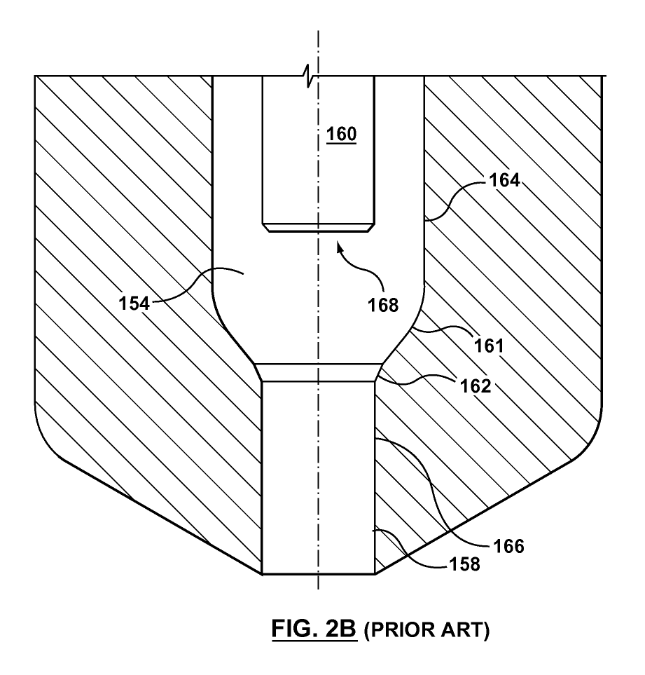

Another example of a prior art channel for conveying fluid (such as melt) is illustrated with reference to FIG. 2A and FIG. 2B. FIG. 2A is a sectional view of a hot runner nozzle 156 for a hot runner 152, implemented according to known prior art techniques. FIG. 2B is an enlarged sectional view of a portion of the hot runner nozzle 156 shown in FIG. 2A. As shown in FIG. 2A, a melt distribution channel 150 in the hot runner 152 feeds melt into a nozzle channel 154 in the hot runner nozzle 156. The melt flows to a valve gate 158 that is selectively opened and closed by movement of a valve stem 160 in a manner that is well known to those of skill in the art.

With continued reference to FIG. 2A and with reference to FIG. 2B, the nozzle channel 154 has a first channel portion 164, fluidly connected to a second channel portion 166 by means of a transition portion 161. The first channel portion 164 is associated with a comparatively larger cross-section, while the second channel portion 166 is associated with a comparatively smaller cross-section relative to each other.

The transition portion 161 is, therefore, intended to provide a transition channel defining a flow path for the melt from a first conduit having a larger cross-section (i.e. the first channel portion 164) to a second conduit having a smaller cross-section (i.e. the second channel portion 166). The shape of the transition portion 161 can be said to be generally conical. Accordingly, it can be said that the transition portion 161 is associated with a sharp curvature, as well as a discontinuity 162 between the transition portion 161 and the second channel portion 166. It is believed that the sharp curvature and/or the discontinuity 162 can lead to undesirable flow characteristics.

U.S. Pat. No. 5,192,556 issued to Schmidt on Mar. 9, 1993 provides a system that delivers a melt stream of moldable plastic material under pressure through a flow passageway into a mold cavity and includes a distributing plate including a distribution channel for conveying a plastic melt, a nozzle including a mold channel therein which communicates with the distribution channel and a mold cavity communicating with the mold channel. A connecting channel is provided connecting the distribution channel with the mold channel.

U.S. Pat. No. 6,464,488 issued to Dray on Oct. 15, 2002 provides a sliding ring non-return valve primarily for use with an injection molding machine utilizing a frame having cut therein one or more longitudinal grooves. Material flows around the outer edge of a flange surface, into an inlet area, and through the longitudinal grooves in the frame's outer surface before entering an accumulation volume. A ring, dimensioned to fit slidably around the frame, blocks material flow into the grooves while in an upstream position and allows material to pass through the grooves while in a downstream position. In an alternative embodiment, the non-return valve utilizes a frame that surrounds a central passage accessed by inlets. The outlet passage is located downstream of said inlet and connects the central passage with an accumulation volume. A ring is dimensioned to slidably fit around the frame. A flange surface limits the ring's upstream travel, while grooves in the flange surface throttle, or limit, material flow into the inlet area. In an upstream position, the ring blocks material flow into the inlets. In a downstream position, the ring allows positive material flow from the inlet to the outlet. The material backflow around a downstream restraining cap forces the ring to its upstream position prior to the injection stroke.

U.S. Pat. No. 6,520,762 issued to Kestle et al. on Feb. 18, 2004 provides a barrel assembly and carriage assembly preferably having first complementary couplers and second complementary couplers. The first couplers interlock to secure the barrel assembly between the ends of the barrel assembly to a carriage assembly. The second couplers retain an end of the barrel assembly in the carriage assembly preventing rotation of the barrel assembly during operation.

U.S. Pat. No. 6,887,062 issued to Burg et al. on May 3, 2005 provides a screw nose for a rubber extruder screw and has an upstream portion of increasing diameter providing working engagement of the rubber flowing from the screw with the extruder barrel and a downstream portion of decreasing diameter providing working engagement of the rubber with a converging tapered wall of a flow channel block for reducing the shrinkage and pressure drop at the discharge end of the screw and thereby prevent porosity and blisters in an extruded rubber component.

PCT patent application bearing a publication number 03/004247 A1 by Visscher published on Jan. 16, 2003 provides a device for extruding a thermoplastic polymer into a tube, comprising means for annular feed of tube material for extrusion to an extruder head which comprises an extruder head gap with an inner wall and an outer wall, wherein the inner wall and/or the outer wall of the diverging conical gap and/or of the converging part of the compression gap is provided with guide structures running in axial direction for tube material. The invention also relates to an extruder head in accordance with the above stated device.

Generally speaking, it can be said that all of these patent references provide a transition channel with sharp discontinuities in the flow path.

### SUMMARY OF INVENTION

According to a first broad aspect of the present invention, there is provided a transition channel for providing a flow path between a first conduit having a first cross-section and a second conduit having a second cross-section in a molding system. The transition channel comprises an inner surface having a shape that is configured to follow a curve that substantially corresponds to melt natural stream lines.

According to a second broad aspect of the present invention, there is provided a barrel head for an injection molding machine, the barrel head for providing a path of flow for melt between a barrel portion having a first channel having a first cross-section and a machine nozzle having a second channel having a second cross-section. The barrel head comprises an internal channel defining: an entry portion having a cross-section substantially corresponding to the first cross-section; an exit portion having a cross-section substantially corresponding to the second cross-section; a transition portion having a shape that is configured to follow a curve that substantially corresponds to melt natural stream lines.

According to a third broad aspect of the present invention, there is provided a nozzle channel for a hot runner nozzle of a molding system. The nozzle channel comprises a first channel portion having a first cross-section; a second channel portion having a second cross-section; a transition portion located between the first channel portion and the second channel portion, the transition portion having a shape that is configured to follow a curve that substantially corresponds to melt natural stream lines.

According to a fourth broad aspect of the present invention, there is provided a transition channel for use in an injection molding machine. The transition channel comprises means for joining a first conduit and a second conduit of differing cross-sectional area, the means for joining configured to provide a flow path for the melt that is continuous and devoid of sharp directional changes.

According to another broad aspect of the present invention, there is provided a hot runner valve stem for an injection molding machine. The hot runner valve stem comprises a tip defining an external surface, the external surface having a shape that is configured to follow a curve that substantially corresponds to melt natural stream lines.

According to another broad aspect of the present invention, there is provided a tip of a check valve of a plasticizing screw. The check valve tip comprises an external surface, the external surface having a shape that is configured to follow a curve that substantially corresponds to melt natural stream lines.

According to yet another broad aspect of the present invention, there is provided a hot runner nozzle for an injection molding machine. The hot runner nozzle comprises a nozzle channel defined in the hot runner nozzle, a valve stem extending along the nozzle channel; the valve stem comprising an external surface and the nozzle channel comprising an inner surface, wherein at least one of the external surface and the inner surface has a shape that is configured to follow a curve that substantially corresponds to melt natural stream lines.

These and other aspects and features of embodiments of the present invention will now become apparent to those skilled in the art upon review of the following description of specific non-limiting embodiments of the invention in conjunction with the accompanying drawings.

### DETAILED DESCRIPTION OF DRAWINGS

Embodiments of the present invention will now be described with reference to the accompanying drawings, in which:

FIG. 1A is a partial sectional view of a prior art injection unit for a molding machine.

FIG. 1B is a perspective view of a prior art barrel head for the injection unit shown in FIG. 1A.

FIG. 2A is a sectional view of a prior art hot runner nozzle for a hot runner channel for a molding machine.

FIG. 2B is an enlarged sectional view of a portion of the hot runner nozzle shown in FIG. 2A.

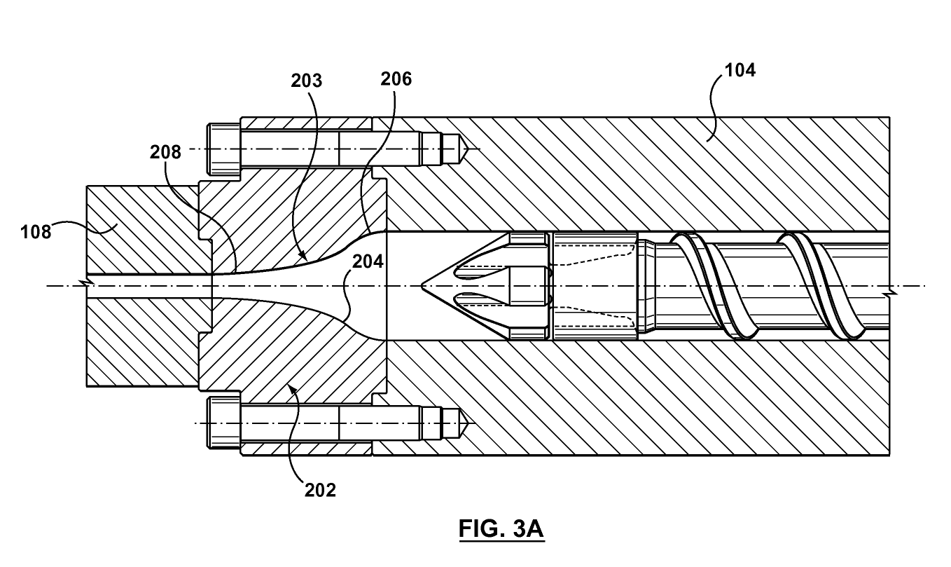

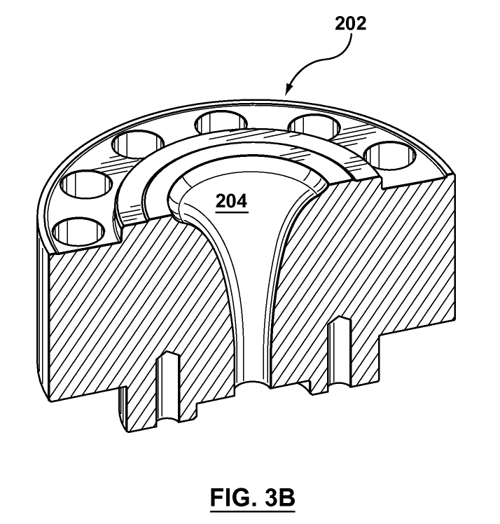

FIG. 3A is a sectional view of an injection unit for a molding machine with a barrel head implemented in accordance with a non-limiting embodiment of the present invention.

FIG. 3B is a perspective view of the barrel head shown in FIG. 3A.

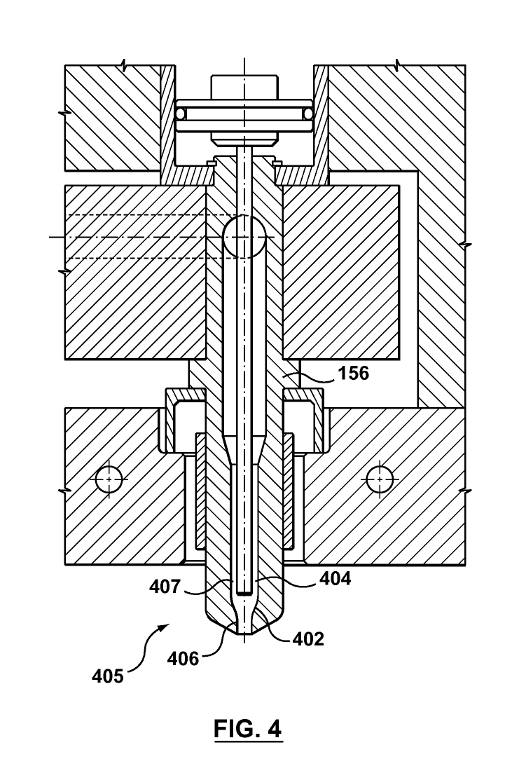

FIG. 4 is a sectional view of a hot runner nozzle for a hot runner channel for a molding machine modified in accordance with embodiments of the present invention.

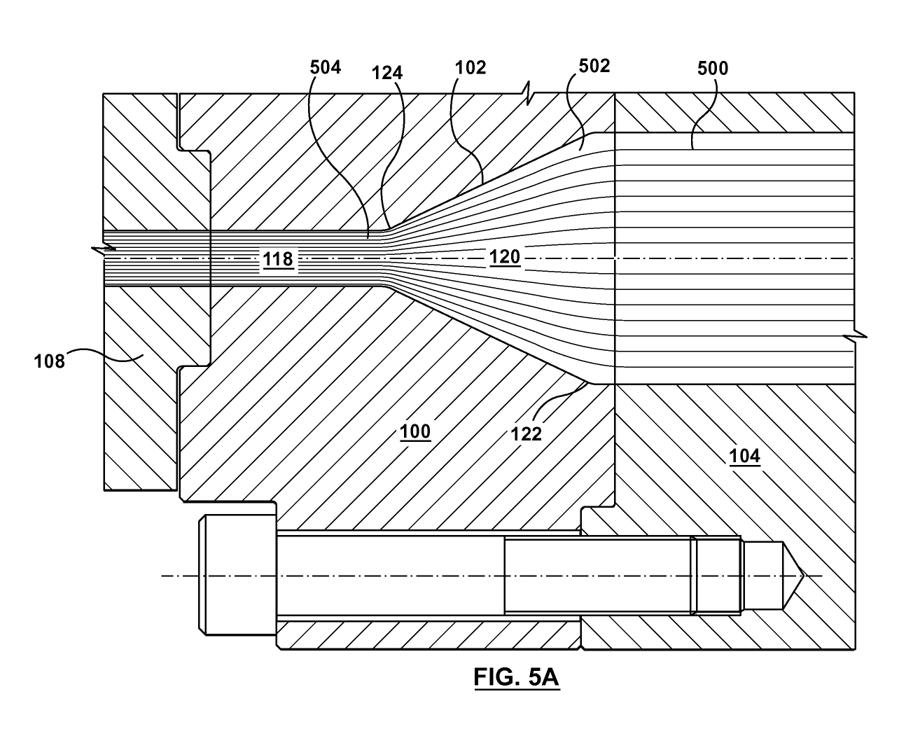

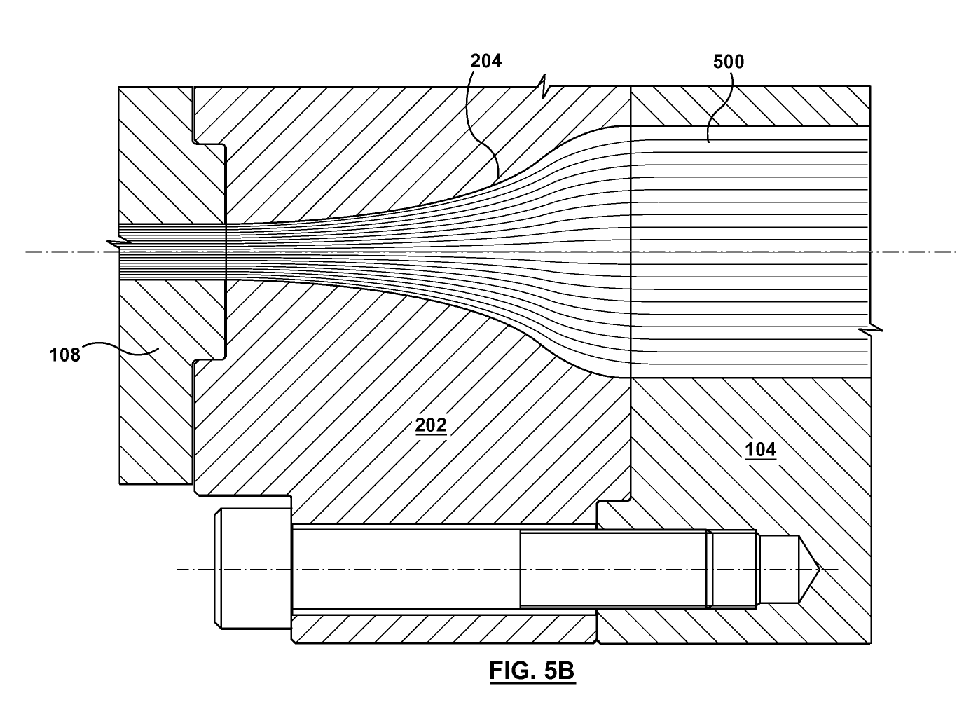

FIG. 5A schematically illustrates a flow path of a melt through a prior art barrel head of FIG. 1A.

FIG. 5B schematically illustrates a flow path of melt through a barrel head of FIG. 3A.

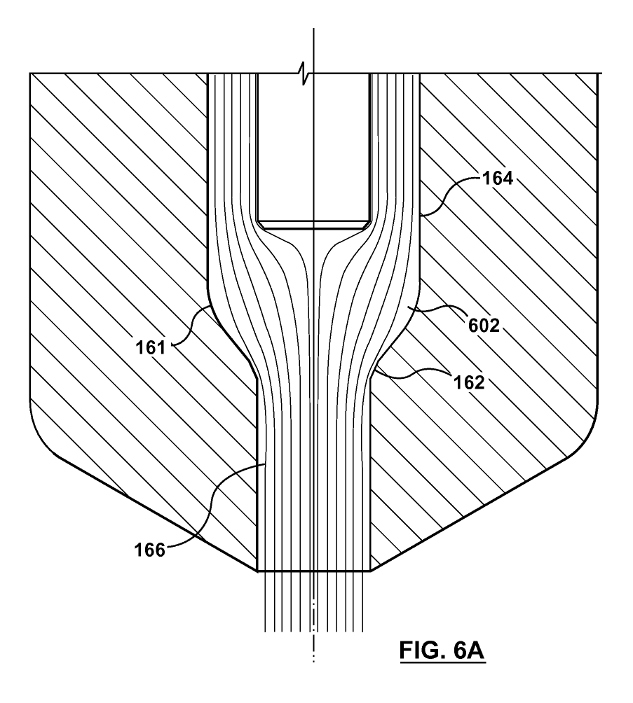

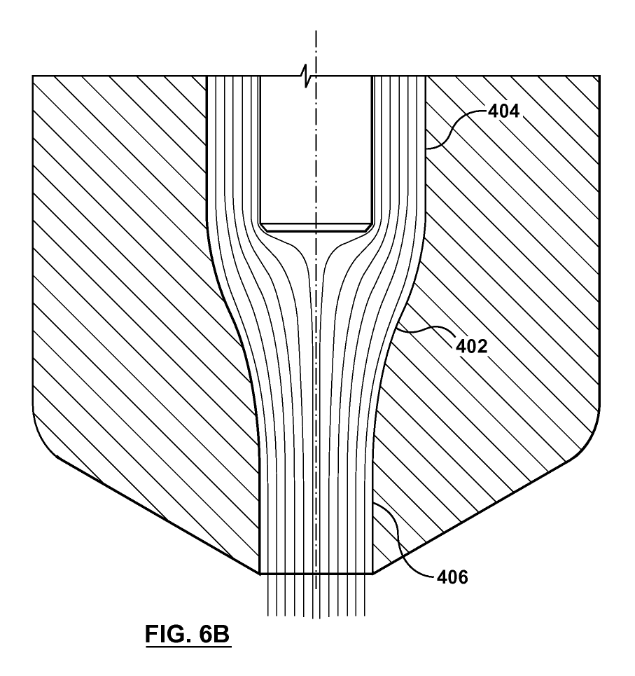

FIG. 6A schematically illustrates a flow path of melt through a prior art hot runner nozzle of FIG. 2A.

FIG. 6B schematically illustrates a flow path of melt through a hot runner nozzle of FIG. 4.

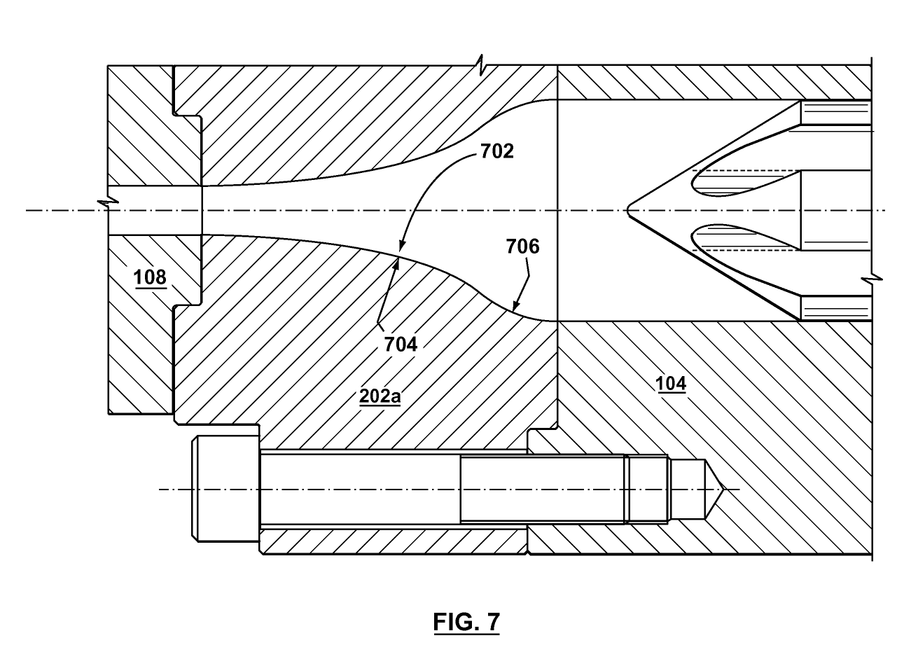

FIG. 7 schematically illustrates a barrel head implemented according to another non-limiting embodiment of the present invention.

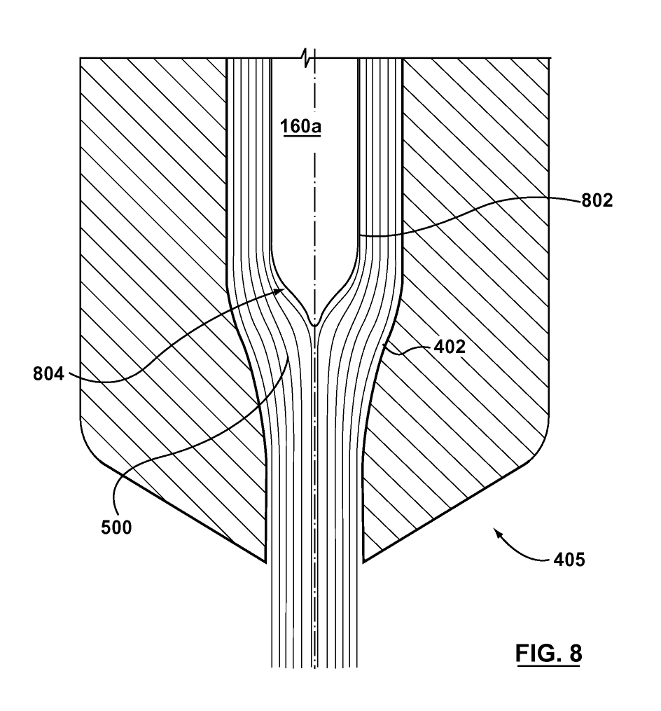

FIG. 8 schematically illustrates a hot runner nozzle with a valve stem illustrated according to a non-limiting embodiment of the present invention.

### DETAILED DESCRIPTION OF EMBODIMENTS

Inventors have appreciated that there exists a problem with known transition devices (such as, for example, the barrel head 100 having the internal channel 102 of FIG. 1A or the transition portion 161 of the hot runner nozzle 156 of FIG. 2A) that provide a transition channel defining a flow path for a flow of fluid (such as melt, for example) between a first conduit of a larger cross-section to a second conduit of a smaller cross-section.

One potential problem can be illustrated with reference to FIG. 1A and FIG. 1B, which show the first sharp discontinuity 122 and the second sharp discontinuity 124, whereby each provides a sharp transition point that may lead, for example, to a local increase in temperature of the melt and, thus, resulting in a melt having an uneven temperature distribution. Additionally or alternatively, the first sharp discontinuity 122 and the second sharp discontinuity 124 can disrupt the uniformity of the flow of the melt. Inventors believe that these changes in the melt characteristics can create an inhomogeneous melt or lead to an imbalance in the runner system.

Inventors believe that the change in properties of the melt (such as, for example, temperature distribution) across the channel can create molded articles of varying quality. Exposure of some melts, such as for example, PET melt during an injection molding process to high shear rates and elevated temperatures increases Acetaldehyde (AA) levels in the molded article leading to a reduced or even unacceptable quality container.

Zones with decreased rate velocity of flow can also develop around the first sharp discontinuity 122 and/or the second sharp discontinuity 124 of FIG. 1A and FIG. 1B. These zones can also cause significant problems when changing the color of the melt in the channel since the prior color may take longer to be completely expelled from the internal channel 102.

Inventors further believe that some of the problems are attributable, at least in part, to a shape of the transition channel (in this example, the internal channel 102) and, more specifically, the shape that does not correspond to melt natural stream lines, as will be discussed in further detail herein below.

Similarly, within the illustrations of FIG. 2A and FIG. 2B, the sharp curvature of the transition portion 161 and/or the discontinuity 162 between the transition portion 161 and the second channel portion 166 can disrupt the uniformity of the flow of the melt. Additionally or alternatively, the sharp curvature of the transition portion 161 and/or discontinuity 162 can lead to local increase of shear rates and, thus, to local increase of temperature. Additionally or alternatively, a large dead zone 168 is created in the wake of the valve stem 160. This dead zone 168 can cause loss of energy of the fluid and can lead to longer residence time of the melt resulting, for example, in increased time required for color change.

Reference is now made to FIG. 3A, which depicts the barrel portion 104 and the machine nozzle 108 that are substantially similar to those of FIG. 1A and, as such, like numerals depict like elements. Within FIG. 3A, there is depicted a barrel head 202 implemented according to a non-limiting embodiment of the present invention. The barrel head 202 is substantially similar to the barrel head 100 shown in FIG. 1A, except that the barrel head 202 comprises an internal channel 203 implemented according to a non-limiting embodiment of the present invention. The internal channel 203 comprises three transition regions. More specifically, the internal channel 203 comprises an entry portion 206, an exit portion 208 and a transition portion 204. The transition portion 204 is disposed between the entry portion 206 and the exit portion 208.

It can be seen that the entry portion 206 has a cross-section that generally corresponds to the first cross-section of the first channel 106 and a cross-section of the exit portion 208 generally corresponds to the second cross-section of the second channel 110. Accordingly, it can further be seen that the cross-section associated with the entry portion 206 is greater than the cross-section associated with the exit portion 208. Accordingly, it can be said that the transition portion 204 is configured to provide a transition channel defining a flow path for melt between a first conduit associated with a larger cross-section (i.e. the entry portion 206) and a second conduit associated with a smaller cross-section (i.e. the exit portion 208).

The transition portion 204 has an inner surface that has a shape that follows a curve that substantially corresponds to melt natural stream lines. In the specific embodiment being illustrated in FIG. 3A, this shape comprises a substantially hyperboloidal curve (this shape is best seen in FIG. 3B).

A technical effect, amongst others, of this embodiment of the present invention can be said to include provision of a transition portion 204 that provides a path of flow that is free of impediments to the travel of the melt so that the entire melt flows through the barrel head 202 without any disruptive influences from discontinuities that existed with prior art designs. Put another way, the transition portion 204 provides, in use, a more gradual transition from the barrel portion 104 to the machine nozzle 108 so that the melt flowing between the first channel 106 of the barrel portion 104 towards the second channel 110 of the machine nozzle 108 tends to maintain position with respect to other parts of the melt in the respective first and second channels 106, 110.

A technical effect of this embodiment of the present invention can be best appreciated by comparing illustrations of FIG. 5A and FIG. 5B. FIG. 5A illustrates the melt flow within the barrel head 100 of FIG. 1A. More specifically, FIG. 5A illustrates, schematically, melt natural stream lines 500 of the melt. It can be clearly seen in FIG. 5A that the shape of the internal channel 102 does not follow the melt natural stream lines 500. It is believed that this shape and, more specifically, the first and second sharp discontinuities 122, 124 can lead to some of the following undesirable conditions: (a) non-uniform sudden changes in the flow patterns of the melt, (b) increased shear in portions of the melt and (c) changes of pressure within portions of the melt and create dead spots along the channel. Some of these conditions or a combination of these conditions can lead to decreased quality associated with the produced molded article.

As has been discussed in more detail herein above, the first sharp discontinuity 122 can cause a lower velocity of the melt in the proximity to the first sharp discontinuity 122 (i.e. in an area 502). This can lead to the melt to build up along the wall of the transition channel 102 in the area 502 proximate to the entrance to the third transition portion 120. This build up can cause problems, for example, during color change, as the old color can take longer to be completely expelled from the area 502.

Similarly, the second sharp discontinuity 124 can cause increased shear rate associated with the melt flowing along the sidewall of the internal channel 102 proximate to the second sharp discontinuity 124 in an area depicted at 504. This in turn can lead to local loss of pressure and/or increased local temperature in the area 504.

As illustrated in FIG. 5B, which depicts the barrel portion 104, the machine nozzle 108 and the barrel head 202 of FIG. 3A, the transition channel 204 of the barrel head 202 provides for more natural transition of the melt with no zones with decreased velocity or sharp discontinuities, as the barrel head 202 comprises the transition portion 204 that follows a curve that substantially corresponds to melt natural stream lines 500. It can be seen that the transition portion 204 is continuous and has no sharp discontinuities so the melt flow tends to be substantially uniform with no pressure drops or sharp direction changes, so all parts of the melt maintain their relative position with respect to all other parts of the melt as the melt flows between the barrel portion 104 and the machine nozzle 108 via the barrel head 202.

As illustrated in FIG. 5B, in the barrel head 202 having a transition portion 204 implemented according to embodiments of the present invention, the melt flow follows curvature of the transition portion 204 without abrupt changes in the flow direction. Accordingly, it can be said that a technical effect of an embodiment of the present invention includes provision of a shape of the transition portion 204 that conforms to the lowest flow resistance, minimizing the pressure drop, shear rate and temperature rise of the melt due to shear heating.

FIG. 4 shows a hot runner nozzle 405. The hot runner nozzle 405 comprises a nozzle channel 407 modified according to a non-limiting embodiment of the present invention. The hot runner nozzle 405 of FIG. 4 can be substantially similar to the hot runner nozzle 156 of FIG. 2A, but for the specific differences discussed herein below and, as such, like elements are depicted with like numerals.

The nozzle channel 407 has a first channel portion 404, fluidly connected to a second channel portion 406 by means of a transition portion 402. The first channel portion 404 is associated with a comparatively larger cross-section, while the second channel portion 406 is associated with a comparatively smaller cross-section relative to the first channel portion 404. The transition portion 402 is, therefore, intended to provide a transition channel defining a flow path for the melt from a first conduit having a larger cross-section (i.e. the first channel portion 404) to a second conduit having a smaller cross-section (i.e. the second channel portion 406).

According to this embodiment of the present invention, the transition portion 402 comprises an inner surface that is configured to follow a curve that substantially corresponds to melt natural stream lines 500. In the specific non-limiting embodiment depicted in FIG. 4, the transition portion 402 is associated with a hyperboloidal curve. A technical effect of these embodiments of the present invention is best seen when comparing an illustration in FIG. 6A and an illustration in FIG. 6B. Illustrations in FIG. 6A and FIG. 6B compare the melt flow paths of the melt in the hot runner nozzle 156 of FIG. 2A and the hot runner nozzle 405 of FIG. 4.

As shown in FIG. 6A the sharp curvature of the conical shape of the transition portion 161 surface can create local increase in shear rate in an area 602 where the surface has its sharpest change of direction and, accordingly, lead to local increase in temperature. As shown in FIG. 6B, the transition portion 402 that follows a curve that substantially corresponds to melt natural stream lines 500 changes the direction of the melt flow evenly so no sharp transition point is created. In addition, the transition portion 402 does not have a sharp directional change at a location where it joins the second channel portion 406. This also helps to smooth out the flow of the melt whereas the discontinuity created by the discontinuity 162 between the conical surface and the gate area 604 tends to create disruptions in the flow of the melt.

In some embodiments of the present invention, the transition channel (such as, the transition portion 204 or the transition portion 402) can be manufactured by using a known Computer Numerically Controlled (CNC) tool. As will be appreciated by those skilled in the art, a mathematical formulae representing the desired curve is inputted into a processor of the CNC tool and the processor then executes commands to cause the CNC tool to execute a curve corresponding to the inputted mathematical formulae.

Even though the foregoing description has described a transition channel (such as, the transition portion 204 or the transition portion 402) as having hyperboloidal shape, this need not be so in every embodiment of the present invention. For the avoidance of doubt, it should be understood that any shape that follows a curve that substantially corresponds to melt natural stream lines 500 can be used to implement transition channels according to various non-limiting embodiments of the present invention. For example, in an alternative non-limiting embodiment of the present invention, the curve can be paraboloidal. Other alternatives for how the shape that follows a curve that substantially corresponds to melt natural stream lines 500 are, of course, possible. As an example, in an alternative non-limiting embodiment of the present invention, approximation profile can be developed for implementing the shape that follows a curve that substantially corresponds to melt natural stream lines 500. For the avoidance of doubt, the term “approximation profile” means a profile used for manufacturing the inner surface of the transition channel that corresponds substantially closely to the melt natural stream lines 500.

A specific non-limiting embodiment of this alternative implementation is depicted with reference to FIG. 7, which depicts a barrel head 202a. The barrel head 202a can be substantially similar to the barrel head 202, other than for the specific differences discussed herein below. The barrel head 202a comprises a transition channel 702 implemented according to another non-limiting embodiment of the present invention. The transition channel 702 is based on an approximation profile, which in this case comprises two tangent radii—a first radius 704 and a second radius 706. Alternatively, other suitable approximation profiles can be used, such as but not limited to curves made of a combination of short straight lines and the like. Within these embodiments of the present invention, the transition channel (such as, the transition channel 702) based on the approximation profile can be manufactured by using the CNC tool or, alternatively, using known drilling or machining tools that conform to the approximation profile. An additional technical effect of these embodiments of the present invention that use an approximation profile includes comparatively easy and inexpensive manufacturing of the transition channel using standard drilling or machining tools.

It should be noted that even though the transition channel 702 have been depicted as part of the barrel head 202a, it can be also used as part of the nozzle channel 407.

An overall technical effect of some of the embodiments of the present invention can be categorized as provision of a transition channel that substantially minimizes the shear rate increase, minimizes local temperature increase and/or local pressure drops. It should be appreciated, however, that not all of the technical effects mentioned throughout this description need to be present, in their entirety, in each and every embodiment of the present invention.

It should be appreciated that embodiments of the present invention are not limited to an internal flow channel (such as a flow path provided by the internal channel 203 or the nozzle channel 407). Those skilled in the art will appreciate that teachings of the present invention can also be applied to external flows like the flow past the end of the valve stem 160 or a tip of a check valve of the screw 101. Similarly, teachings of the present invention may also be useful on nozzle tips and check valves to provide a streamlined and uniform melt flow. An example of this implementation is depicted in FIG. 8, which depicts a hot runner nozzle 405a implemented according to another non-limiting embodiment of the present invention. The hot runner nozzle 405a can be substantially similar to the hot runner nozzle 405, but for the specific differences discussed herein below. The hot runner nozzle 405a comprises the transition portion 402 similar to that described with reference to FIG. 4. The hot runner nozzle 405a also comprises a valve stem 160a. The valve stem 160a comprises a tip 804. The tip 804 is associated with an external surface that has a shape that follows a curve that substantially corresponds to melt natural stream lines 500. In the specific embodiment being illustrated in FIG. 8, this shape comprises a substantially hyperboloidal curve. Even though in the specific non-limiting embodiment of FIG. 8, both the tip 804 and the transition portion 402 have been depicted as having the shape that follows a curve that substantially corresponds to melt natural stream lines 500, in other non-limiting embodiments of the present invention, one or the other or both of the tip 804 and the transition portion 402 can be associated with the shape that follows a curve that substantially corresponds to melt natural stream lines 500

Even though the foregoing description has illustrated the transition channel providing a flow path between a first conduit having a first cross-section and a second conduit having a second cross-section, the first cross-section being greater than the second cross-section, this not need be so in every embodiment of the present invention. Accordingly it should be understood, the relationship between the first cross-section and the second cross-section can be reversed.

Description of the embodiments of the present inventions provides examples of the present invention, and these examples do not limit the scope of the present invention. It is to be expressly understood that the scope of the present invention is limited by the claims. The concepts described above may be adapted for specific conditions and/or functions, and may be further extended to a variety of other applications that are within the scope of the present invention. Having thus described the embodiments of the present invention, it will be apparent that modifications and enhancements are possible without departing from the concepts as described. Therefore, what is to be protected by way of letters patent are limited by the scope of the following claims:

What is claimed is:

1. A transition channel for providing a flow path between a first conduit having a first cross-section and a second conduit having a second cross-section in a molding system, the transition channel comprising:
an inner surface having a shape that is configured to follow a curve that substantially corresponds to melt natural stream lines.

2. The transition channel of claim 1, wherein said curve is continuous and devoid of sharp directional changes.

3. The transition channel of claim 1, the first conduit comprising an entry portion of a barrel head and the second conduit comprising an exit portion of the barrel head, wherein said transition channel comprises a transition portion located between the entry portion and the exit portion of the barrel head.

4. The transition channel of claim 3, wherein said curve is substantially hyperboloidal.

5. The transition channel of claim 3, wherein said curve is substantially paraboloidal.

6. The transition channel of claim 3, wherein said curve is based on an approximation profile.

7. The transition channel of claim 6, wherein said approximation profile comprises two tangent radii.

8. The transition channel of claim 1, the first conduit comprising a first channel portion of a nozzle channel of a hot runner nozzle and the second conduit comprising a second channel portion of the nozzle channel, wherein said transition channel comprises a transition portion located between the first channel portion and the second channel portion of the nozzle channel.

9. The transition channel of claim 8, wherein said curve is substantially hyperboloidal.

10. The transition channel of claim 8, wherein said curve is substantially paraboloidal.

11. The transition channel of claim 8, wherein said curve is based on an approximation profile.

12. The transition channel of claim 11, wherein said approximation profile comprises two tangent radii.

13. A barrel head for an injection molding machine, the barrel head for providing a path of flow for melt between a barrel portion having a first channel having a first cross-section and a machine nozzle having a second channel having a second cross-section, the barrel head comprising:
an internal channel defining:
an entry portion having a cross-section substantially corresponding to the first cross-section;
an exit portion having a cross-section substantially corresponding to the second cross-section;
a transition portion having a shape that is configured to follow a curve that substantially corresponds to melt natural stream lines.

14. The barrel head of claim 13, wherein said curve us substantially hyperboloidal.

15. The barrel head of claim 13, wherein said curve is substantially paraboloidal.

16. The barrel head of claim 13, wherein said curve is based on an approximation profile.

17. The barrel head of claim 13, wherein said approximation profile comprises two tangent radii.

18. The barrel head of claim 13, wherein said curve is continuous and devoid of sharp directional changes.

19. A nozzle channel for a hot runner nozzle of a molding system, the nozzle channel comprising:
a first channel portion having a first cross-section;
a second channel portion having a second cross-section;
a transition portion located between the first channel portion and the second channel portion, the transition portion having a shape that is configured to follow a curve that substantially corresponds to melt natural stream lines.

20. The nozzle channel of claim 19, wherein said curve us substantially hyperboloidal.

21. The nozzle channel of claim 19, wherein said curve is substantially paraboloidal.

22. The nozzle channel of claim 19, wherein said curve is based on an approximation profile.

23. The nozzle channel of claim 19, wherein said approximation profile comprises two tangent radii.

24. The nozzle channel of claim 19, wherein said curve is continuous and devoid of sharp directional changes.

25. In an injection molding machine, a transition channel comprising:
means for joining a first conduit and a second conduit of differing cross-sectional areas, said means for joining configured to provide a flow path for the melt that is continuous and devoid of sharp directional changes.

26. The transition channel of claim 25, wherein said means for joining have a shape that is configured to follow a curve that substantially corresponds to melt natural stream lines

27. A hot runner valve stem for an injection molding machine, said hot runner valve stem comprising:
a tip defining an external surface, said external surface having a shape that is configured to follow a curve that substantially corresponds to melt natural stream lines.

28. The hot runner valve stem of claim 27, wherein said curve comprises one of a substantially hyperboloidal curve, a substantially paraboloidal curve and a curve based on an approximation profile.

29. A tip of a check valve of a plasticizing screw, said check valve tip comprising:
an external surface, said external surface having a shape that is configured to follow a curve that substantially corresponds to melt natural stream lines

30. The tip of claim 29, wherein said curve comprises one of a substantially hyperboloidal curve, a substantially paraboloidal curve and a curve based on an approximation profile.

31. A hot runner nozzle for an injection molding machine, the hot runner nozzle comprising:
a nozzle channel defined in said hot runner nozzle,
a valve stem extending along said nozzle channel;
said valve stem comprising an external surface and said nozzle channel comprising an inner surface, wherein at least one of said external surface and said inner surface has a shape that is configured to follow a curve that substantially corresponds to melt natural stream lines.
